(19) United States
(12) Patent Application Publication
(10) Pub. No.: US 2008/0177709 A1
(43) Pub. Date: Jul. 24, 2008

(54) Data updating method for internet map service platform and Internet map service platform system

(75) Inventors: Yang-Po Chiu, Taipei (TW); Ying-Fung Lau, Taipei (TW); Yi-Hsiu Lee, Taipei (TW); Hung-Hsiung Chen, Taipei (TW); Ming-Kai Shiau, Taipei (TW); Yu-Liu Hsu, Taipei (TW); Chih-Wen Hsieh, Taipei (TW); Hsin-Ying Chen, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 12/000,990

(22) Filed: Dec. 19, 2007

(30) Foreign Application Priority Data
Dec. 19, 2006 (TW) 95147749

(51) Int. Cl. G06F 15/16; G06F 17/30

(52) U.S. Cl. 707/3; 709/218; 707/200; 707/1; 707/E17.009; 707/E17.014

(57) ABSTRACT

A data updating method for an Internet map service platform and a system thereof are applied to an electronic device. The electronic device is linked to an Internet map service platform by a wire or wireless network, and the Internet map server platform has a plurality of map data. The method includes the following steps: logining the map service platform; getting a piece of map data of a present location from the map service platform; recording a piece of route data including GPS locus of the present location; comparing the gotten map data with the route data to find whether they have a difference; and uploading the route data having the difference to the map service platform.

### BACKGROUND OF THE INVENTION

1. Field of the Invention

The invention relates to an Internet map service platform and, more particularly, to a data updating method for an Internet map service platform.

2. Description of the Related Art

In recent years, the application field of the global positioning system (GPS) is gradually transferred from the military to the people's livelihood, and the GPS is broadly applied in the commerce, shipping and entertainment fields.

As the GPS technology becomes maturer and maturer, its application field becomes broader and broader, and its application market is expanded with the successive appearance of the wireless communication products combined with the GPS. At present, a mobile communication device such as a mobile phone, a smart phone, a personal digital assistant (PDA) with communication function can get on a network, can be linked to a great amount of various types of websites via the wireless transmission of base stations and the Internet, and can get data from the websites by inputting keywords into the searching window on a wet page.

Please refer to FIG. 1 which is a schematic diagram showing a conventional Internet map service platform. A conventional Internet map provides services including a map inquiring function, a route plan function, a traffic situation inquiring function and so on, and mostly provides the map inquiring function and the route plan function; wherein the map inquiring function is to inquire according to an address, the name of a store, a crossroads or other factors. And some other Internet maps also provide the service of introducing scenic spots such as combining a google map with GPS photographs to show a user where a beautiful landscape is or where the photographs are taken.

Generally speaking, the conventional Internet map service utilizes a digital camera and a GPS location measuring apparatus, wherein the GPS location measuring apparatus is coupled to the digital camera to record a passed route and the GPS coordinate location of a place where the digital camera takes photographs, and the digital camera whose time is corrected is used to take photographs along the way. Specific software converts and outputs the GPS coordinate location, designates a file catalog, compares the record time of the locus with the photographing time in the exchangeable image file format (EXIF) of the photographs taken by the digital camera, outputs a file, and rewrites the coordinate data to EXIF. And finally, the photographs can be captured and displayed via the google map.

The above functions are built-in digital cameras by some camera manufacturers. When the above digital cameras are used to take photographs, the GPS coordinate locations are directly recorded in the EXIF file of the photographs, and the method for making the digital photographs have the GPS coordinate locations by recording GPS coordinates by the GPS measuring apparatus and then integrating data by the software is not needed. But the above two modes both have a common defect that the captured photographs cannot be shared with others instantly. Common users do not necessarily carry notebooks when traveling, and then files only can be sorted out until the travel is over and be uploaded to blogs or some wet pages which can store photographs by a personal computer to share with the public.

Considering mobile communication devices, mobile phones with built-in GPS modules are also used. GPS is set as a requisite configuration of some mobile phones with brand names to provide a photograph navigation function, but when the mobile phones with brand names are operated to work in a map or photograph navigation mode, the needed map data are usually pre-built-in the mobile phones or other devices, and specific software needs to be downloaded to realize data updating. Generally speaking, the manufacturers only provide a downloading function, and do not provide a function of uploading data to modify map data or a function of uploading captured photographs to update new point of interesting (POI) data instantly.

Please refer to FIG. 2 which is a schematic diagram showing an Internet map and points of interesting shown on a mobile communication device. For example, a user utilizes the map inquiring function of the mobile communication, logins an Internet map service platform through a wireless Internet access, and keys in the location of a start point A and the location of an end point B, and then the Internet map service platform can provide a navigation route. Furthermore, when utilizing the route inquiring function, the user also can require to display peripheral points of interesting. The mobile communication device can link the Internet (access the Internet) or search a POI through a navigation system, and when a user inputs a key word “noodles” into a searching window on a web page, the wet page displays names of every type of web pages which are related with “noodles” or nearby points of interesting 21, 22, 23 and 24 on the map.

Vehicular navigation devices sold on the market or common Internet map service platforms only provide two types of navigation modes, namely, an optimal route and a shortest route. That is, a GPS module cooperated with an electronic map provides a user with an optimal suggestion navigation route. However, Taiwan is a region with irregular streets and a lot of alleys, and then the electronic map only can navigate in an approximate direction and cannot perfectly provide a detailed navigation function in the alleys of a local region, which makes the objective of setting a vehicular navigation device is not well achieved for the navigation function cannot be thoroughly carried out when a user drives a vehicle.

The manufacturers update POI on an Internet map in a very slow speed, and often update once a half to one year, and therefore, users often find that some stores are closed or relocated when following up the Internet map, or the data is wrong when they login.

However, during driving a vehicle, a driver can become more familiar with the road situation of a region because of accumulated experience, or can find a further preferred route because of occasionally losing the way. The above situations increase the efficiency of the driving (PS. To greatly increase the speed is achieved by pressing the accelerator), but the present navigation devices cannot effectively record a personal route and the common Internet map service platform cannot provide the users with a function of publishing a new route by themselves, and then, if the users cannot clearly remember the preferred route, they only can move forward along the navigation route, which is one of defects of the present vehicular navigation devices and the Internet maps. During driving a vehicle, the users often find some preferred scenic spots or stores, but since the common Internet map service platform cannot provide the users with an authority of modifying map data, the above points of interesting cannot be uploaded to the Internet map service platform to be shared with all users of the Internet map and only can be provided at the users' blogs or some wet pages to be shared.

Therefore, the main objective of the invention is to provide an Internet map service platform which can upload and display updated map data instantly and share a travel record, and the Internet map service platform utilizes a system which can upload and download data instantly of a remote mobile communication electronic device and makes it cooperate with programs of the Internet map service platform to solve the above problem.

### BRIEF SUMMARY OF THE INVENTION

An objective of the invention is to provide a data updating method for an Internet map service platform, wherein the method utilizes electronic devices which can be linked to the Internet to upload edited data to the map service platform instantly through the Internet, and the map service platform can make the data become public as a subject on the platform to enable other remote users to download.

The invention provides a data updating method for an Internet map service platform, and the method is applied in an electronic device which can be linked to the Internet map service platform by a wire or wireless network. The method includes editing data having global positioning system (GPS) locus, logining in the map service platform, and uploading the data having GPS locus to the map service platform.

An embodiment of the invention provides an Internet map service platform system which can upload and display a travel record for sharing instantly, and the system utilizes electronic devices which can be linked to the network to upload digital photographs or movies having global positioning system (GPS) locus to the Internet map service platform instantly through the network. The Internet map service platform makes a mapping with the Internet map via the GPS locus recorded in an exchangeable image file format (EXIF) and makes it become public as a subject on the platform to enable other remote users to download.

An embodiment of the invention provides a data updating method for an Internet map service platform, and the method is applied to an electronic device which can be linked to the Internet map service platform by a wire or wireless network, and the Internet map service platform includes a plurality of map data. The method includes following steps: logining the map service platform; getting a piece of map data of the present location from the map service platform; recording a piece of route data including GPS locus of the present location; comparing the gotten map data with the route data to find whether they have a difference; and uploading the route data having the difference to the map service platform.

To solve the defect of the conventional Internet map service platform which cannot upload and display the updated map data or increase a point of interesting (POI) instantly to update the Internet map data effectively, the invention provides a method which can upload and display the updated map data and increase a point of interesting (POI) instantly and an Internet map service platform which can upload a travel record for sharing at any time. The Internet map service platform is constructed from a series of existing hardware. Consumers are unnecessarily to buy additional devices and can enjoy the convenience brought by the Internet map service platform, which is very economical for the consumers.

### BRIEF DESCRIPTION OF THE SEVERAL VIEWS OF THE DRAWINGS

FIG. 1 is a schematic diagram showing a conventional Internet map service platform.

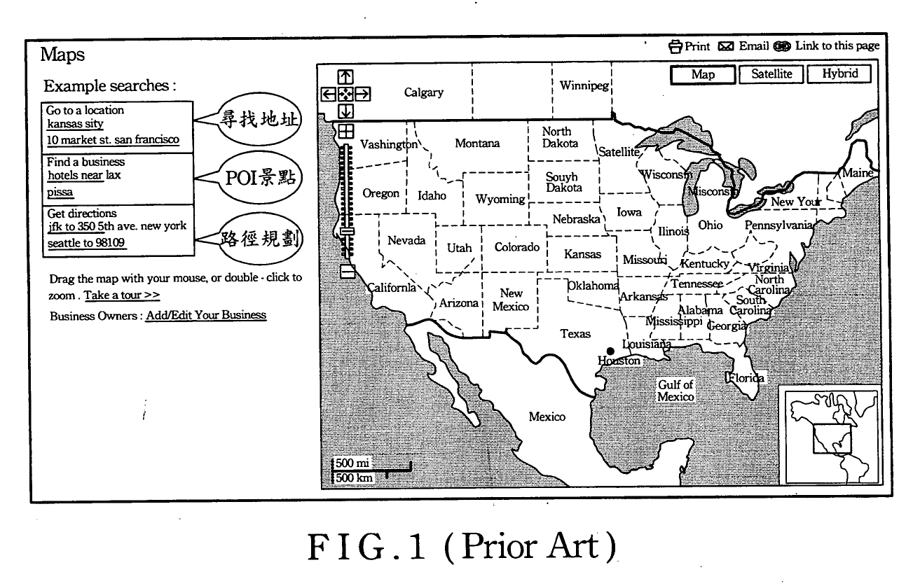

FIG. 2 is a schematic diagram showing a conventional Internet map service platform which provides data.

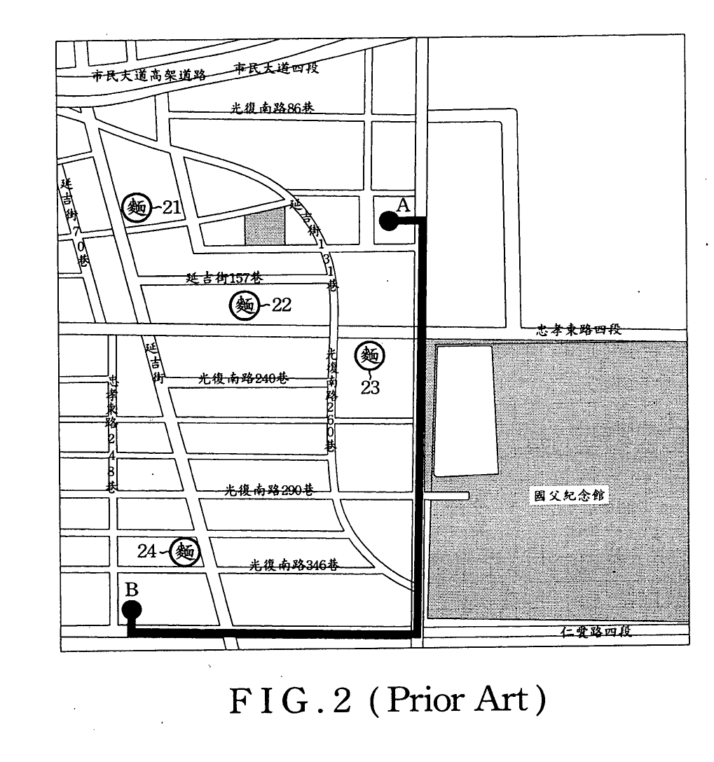

FIG. 3 is a schematic diagram showing an Internet map service platform system in an embodiment of the invention.

FIG. 4 is a flow chart showing the steps of online coediting map data program on an Internet map service platform in an embodiment of the invention.

FIG. 5 is a flow chart showing the steps of online coediting point of interesting (POI) program on an Internet map service platform in an embodiment of the invention.

FIG. 6 is a flow chart showing the steps of online travel record program on an Internet map service platform in an embodiment of the invention.

### DETAILED DESCRIPTION OF THE EMBODIMENTS

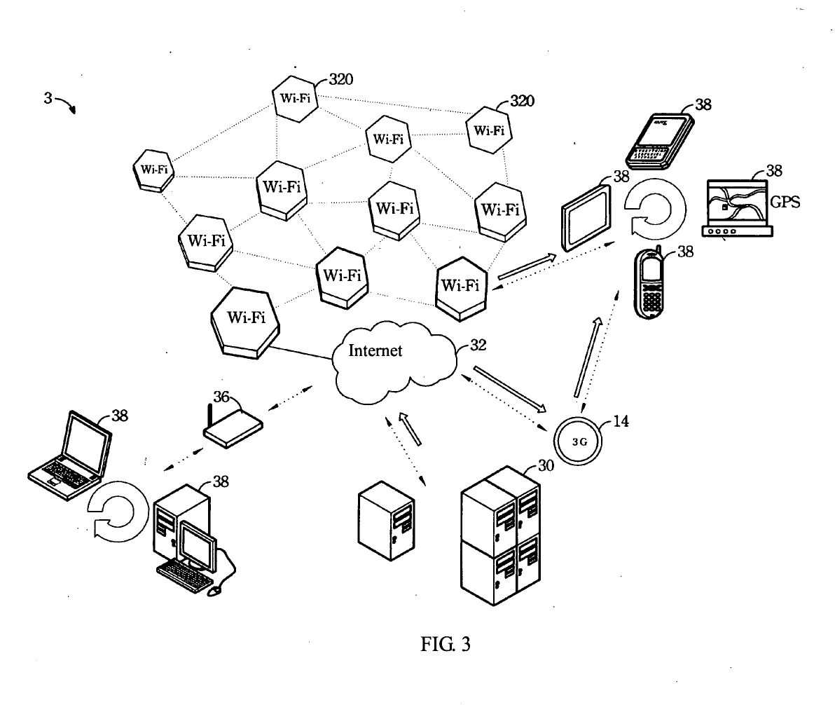

FIG. 3 is a schematic diagram showing an Internet map service platform system in an embodiment of the invention. The Internet map service platform system 3 includes a server 30, the Internet 32, a third-generation mobile communication equipment base station 34, a wire or wireless access point 36 and plural types of electronic devices 38 which can get on the Internet by a wire or wireless network.

In the system, the map service platform is constructed on the server 30, wherein a plurality of map data which is built-in the map service platform is stored in the server 30, and the server 30 can be linked to the electronic devices 38 via the network to make the electronic devices 38 get data.

The Internet 32 includes a wire transmitting mode and a wireless transmitting mode such as a wireless fidelity (Wi-Fi) 320 which connects the server 30 with a plurality of electronic devices 38 to accomplish data transmitting and exchanging.

The third-generation mobile communication equipment base station 34 is connected to the Internet 32 to receive or transmit signals from or to the electronic devices 38 and the Internet 32. The wireless or wire access point 36 is used to connect the electronic devices 38 with the Internet 32.

The plurality of electronic devices 38 are connected to the map service platform via the network and login the map service platform to download or upload data of the map service platform; wherein the electronic devices 38 can be personal digital assistants, third-generation mobile phones, smart phones, vehicular GPS, computers or ultra-mobile personal computers.

In an embodiment, a smart phone 38 is taken as an example to illustrate hereinbelow. The smart phone 38 is connected to the Internet 32 via the Wi-Fi 320 or the third-generation mobile communication equipment base station 34 and further logins the map service platform system; wherein when the smart phone 38 logins the map service platform, a user can determine the function such as a map inquiring function, searching the POI of a particular location or sharing travel records, which he wants to utilize, and the wanted data can be downloaded and displayed by the smart phone.

The user can record the map data, the captured photographs and the points of interesting which are not recorded in the electronic map along the way in the smart phone; when a difference between the above data stored in the smart phone and the route or data provided by the electronic map is found, wherein the difference can be gotten by comparing by the user or by the related program in the smart phone; the difference can be difference between the passed route and the route shown on the electronic map, the wrong display of the electronic map, or the map service platform having been not updated with new and existing electronic map data.

The smart phone can mark the difference, and users decide whether to upload the map data record such as GPS coordinate locus to the map service platform to share with the public. If the user wants to upload new data to the map service platform to share with the public, when the server 30 receives a new message, it makes the new message become public as an opened subject, and all remote users can search out the data and show that they agree or disagree with the subject in a reconsideration mode when they can login the map service platform, and a system administer checks and determines whether the electronic map need to be updated.

The system has a resident program stored in the server 30, and the resident program is mainly used to integrate photograph data uploaded from the electronic devices and the electronic map data to draw an electronic map with an updated route, increase new points of interesting to the electronic map or make a shared travel route diagram. Wherein the shared travel route diagram can be recorded with the time as axis to fully show details of the travel, and the server 30 can provide a simple interface for writing travel notes; in addition, describing the travel progress and the details along the time in a map can utilize other record interface.

The following utilizes three flow charts to illustrate how the Internet map service platform of the invention realizes coediting and maintaining a map, coediting and maintaining a POI, and sharing a travel record online in details.

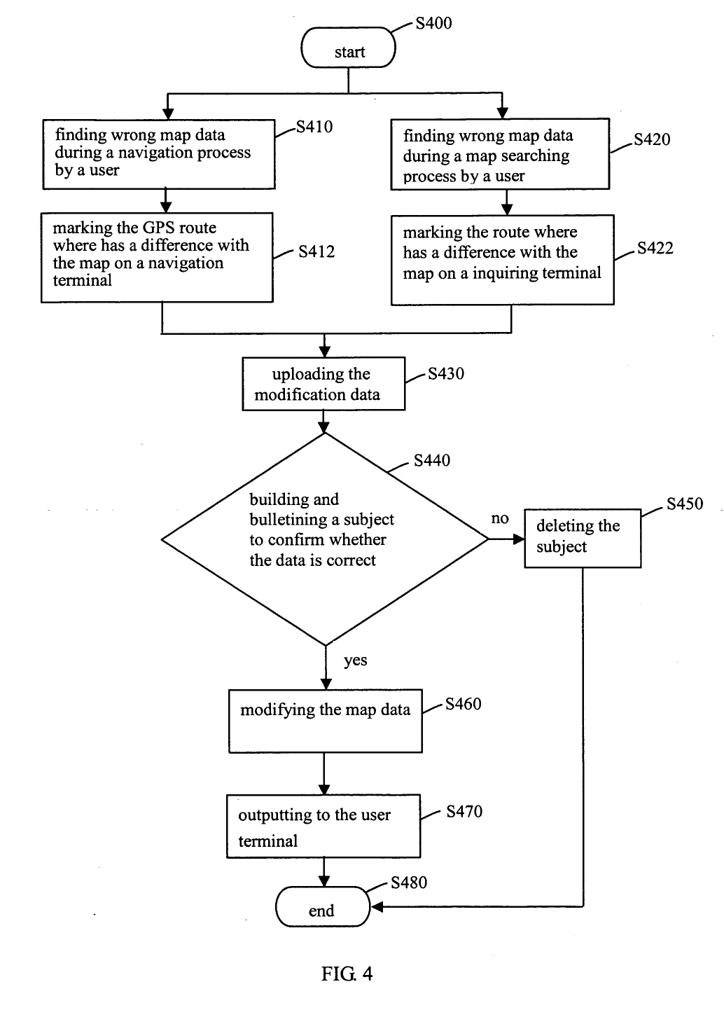

Please refer to FIG. 4 which is a flow chart showing the steps of online (electronically) coediting and maintaining a map on the Internet map service platform in an embodiment of the invention. Wherein when a user uses the map inquiring function or downloads navigation data to an electronic device, the flow path shown in FIG. 4 begins, namely step S400.

That is, it can be divided into two parts, namely, a map inquiring function and a navigation process, to illustrate. During the navigation process, the user utilizes the electronic device to receive the navigation map of the present location from the map service platform and moves along a preferred suggestion route. Step S410 is that the wrong map data provided by the map service platform is found by comparing by the user or the electronic device automatically. Step S412 is that the electronic device can manually or automatically mark the GPS route where has a difference with the electronic map and record the right GPS locus location or the GPS locus location of a new route, and then step S430 follows.

A map inquiring function is that the user inputs the map data of a particular location which he wants to inquire, and the electronic device downloads map data or connects to the map service platform to display the map data. When the user finds the downloaded map data has wrong data in step S420, the route of the electronic map where has a difference with the actual route is marked on the inquiring terminal, namely, the electronic device, in step S422, and step S430 follows.

In step S430, the user can upload new modification data to the map service platform. In step S440, the map service platform receives the modification data, utilizes the resident program to draw a new electronic map and builds a subject which is opened on the map service platform to make other remote users be capable of downloading the subject, and whether the subject is wrong or right can be determined by voting by the users or by confirming by a system administrator.

If the modification message is wrong, step S450 which is deleting the subject follows, and step S480 follows to terminate the flow path. If the modification message is correct, steps S460 in which server modifies the map data to update follows. In step S470, the Internet map service platform bulletins an updating notice, and the modified map data is open to public to be downloaded to electronic device of each remote user. In step S480, the flow path of coediting and maintaining the electronic map of the Internet map service platform is terminated.

Wherein after step S440, the user uploads the modification data to the map service platform and builds a subject, and then all users who download this section of electronic map data or users who browse the newest bulletin area can view the opened new subject and confirm the correctness by voting. The system administrator further can confirm the correctness of the message according to the content of the subject to make an update.

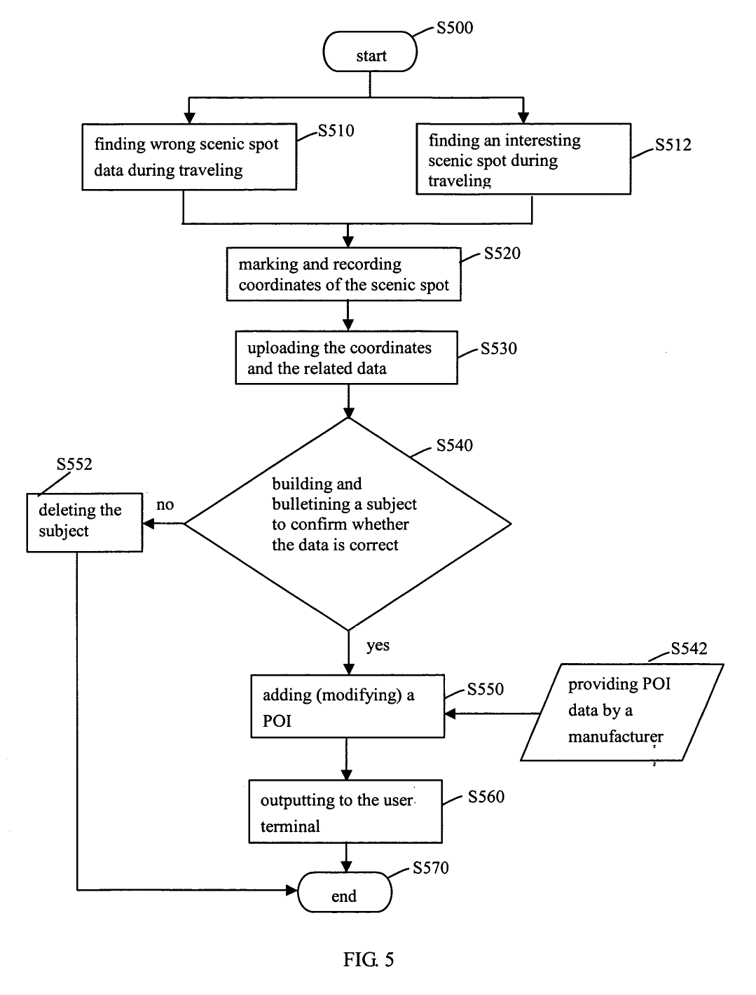

Please refer to FIG. 5, which is a flow chart showing the steps of online coediting and maintaining points of interesting (POI) on an Internet map service platform in an embodiment of the invention. When the user downloads POI data by the electronic device, the flow path shown in FIG. 5 begins from step S500. When the user finds that scenic spot data of POI is wrong, such as wrong record of GPS coordinate location, the scenic spot having been destroyed or developed, or the store having been closed or relocated during the travel in step S510, step S520 follows. Or if the user finds a new POI such as an interesting scenic spot or interesting stores during the travel, step S520 follows.

In step S520, the user can utilize the photographing function and the positioning function of the electronic device to mark the GPS route of a new POI and record related data. In step S530, the correct GPS locus location and data of the new POI or the correct GPS locus location or data of modified POI are uploaded to the map service platform.

In step S540, the map service platform receives new data or data of modified POI, utilizes a resident program to draw a new electronic map and builds a subject which is bulletined in the map service platform to make other remote users be capable of downloading the subject, and whether the subject is wrong or right can be determined by voting by the users or by confirming by a system administrator.

If the modification message is wrong, step S552 in which the subject is deleted follows, and then step S570 follows to terminate the flow path. If the modification message is correct, step S550 in which the server adds a new POI or to modify the data of a POI to make an update follows. However, adding a new POI or modifying the data of a POI can be provided or maintained by manufacturers, and then the manufacturers can directly provide POI data for the server in step S542 which directly follows step S550.

In step S560, the map service platform bulletins an updating notice, and the added or modified POI data is open to public to be downloaded to electronic device of each remote user. In step S570, the flow path of coediting and maintaining the POI data of the Internet map service platform is terminated.

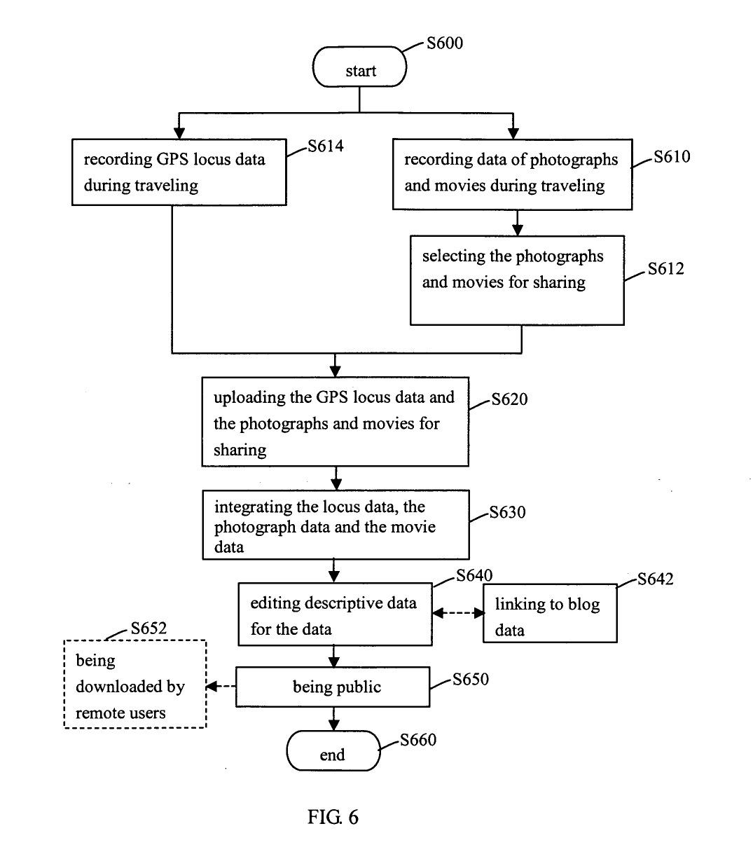

Please refer to FIG. 6, which is a flow chart showing the steps of coediting and maintaining a shared travel record on an Internet map service platform in an embodiment of the invention. When the user makes the electronic device connected to the map service platform and selects an editing function of a shared travel record, the above flow path begins from step S600.

Wherein the electronic device of the user can automatically enters into the step S614 during the travel, record all GPS locus data of the passed route during an entire travel, and upload the data to an Internet map service platform to form a travel route diagram. In step S610, photographs and dynamic movies taken during the travel are stored into the electronic device. In step S612, the user selects the photographs and movies for sharing. In step S620, the user uploads the GPS locus data of the passed route and the photographs and movies for sharing to the map service platform.

In step S630, the map service platform receives the modification data and utilizes a resident program to integrate the data of the GPS locus, the photograph and the movies. In step S640, the server edits descriptive data of the data, converts the GPS coordinate location to output, designates a file catalog, compares the record time of the locus with the photographing time in the exchangeable image file format (EXIF) of digital photographs, outputs a file and rewrites the coordinate data to EXIF to draw a new electronic map according to the passed route. When the server edits the descriptive data of the data, it also can enter into the step S642 in which a blog is linked to provide with data for using and referring according to the authority set by the user.

In step S650, the user can set whom the data is open to, such as the public, friends or family members, and then can confirm that the editing is over to bulletin on the Internet map service platform. In step S652, if the user does not set special limit on the authority, the shared travel data is publicly displayed; if the user limits specific users to view his personal shared travel data, he can set a password with which the shared travel data can be viewed or downloaded to the electronic device of each remote users to share the happiness of the travel with others. In step S660, the flow path for coediting or maintaining the shared travel data on the Internet map service platform is terminated.

Compared with the conventional Internet map service platform, the invention provides an Internet map service platform which can not only utilize a subject mode to update a map or POI data instantly, but also help the system administrator to accelerate the updating operation, so that users can coedit and maintain for the Internet map service platform; the Internet map service platform of the invention further has a shared travel data function, and then all users can upload photographs and GPS locus data instantly to make a travel record, which makes the friends and the family know your situation and share your travel happiness instantly.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A data updating method for an Internet map service platform, wherein the method is applied in an electronic device which is linked to an Internet map service platform by a wire or wireless network, the method comprising the following steps:
editing a piece of data having global positioning system (GPS) locus;
logining the Internet map service platform; and
uploading the data having GPS locus to the Internet map service platform.

2. The method according to claim 1, wherein the data having GPS locus comprises one or random combination of an electronic map, a piece of scenic spot data, a movie, a photograph and a set of coordinate points.

3. The method according to claim 1 further comprising:
confirming that the data having GPS locus is correct; and
updating the data as a piece of map data of the Internet map service platform.

4. The method according to claim 1 further comprising a step of searching the map data of a particular location, wherein the data having GPS locus is modification data of the map data of the particular location.

5. The method according to claim 1, wherein the step of editing a piece of data having GPS locus comprises:
recording the GPS locus coordinates and a related message of a piece of scenic spot data; and
storing the GPS locus coordinates and the related message of the scenic spot data as the data having GPS locus.

6. The method according to claim 1, wherein the data having GPS locus is open to public on the Internet map service platform.

7. The method according to claim 1, wherein the Internet map service platform comprises a reading authority for the data having GPS locus.

8. The method according to claim 1, wherein the Internet map service platform comprises an editing authority for the data having GPS locus.

9. A data updating method for an Internet map service platform, wherein the method is applied in an electronic device which is linked to an Internet map service platform by a wire or wireless network, and the Internet map service platform comprises a plurality of map data, the method comprising the following steps:
logining the Internet map service platform;
getting the map data of a present location from the Internet map service platform;
recording a piece of route data of the GPS locus of the present location;
comparing the gotten map data with the route data to find whether they have a difference; and
uploading the route data having the difference to the Internet map service platform.

10. The method according to claim 9 further comprising:
confirming that the uploaded route data is correct; and
updating the route data as the map data of the Internet map service platform.

11. The method according to claim 9, wherein the map data comprises one or random combination of an electronic map, scenic spot data, an actual image, a photograph and a coordinate point.

12. The method according to claim 9, wherein the route data is open to public on the Internet map service platform.

13. The method according to claim 9, wherein the Internet map service platform comprises a reading authority for the route data.

14. The method according to claim 9, wherein the Internet map service platform comprises an editing authority for the route data.

15. An Internet map service platform system comprising:
a server comprising an Internet map service platform having a plurality of map data; and
a plurality of electronic devices, wherein the electronic devices are capable of being linked to the server by a wire or wireless network and logining the Internet map service platform, and the plurality of the electronic devices are capable of downloading the map data from the Internet map service platform or uploading a piece of data having GPS locus to the map service platform.

16. The Internet map service platform system according to claim 15, wherein the plurality of electronic devices are capable of having a global satellite positioning function and a photographing function.

17. The Internet map service platform system according to claim 15, wherein the server comprises a resident program for integrating the data uploaded from the electronic devices and the plurality of the map data of the server to draw an electronic map with an updated route, increase new points of interesting to the electronic map or make a shared travel route diagram.
